(19) United States
(12) Patent Application Publication
(10) Pub. No.: US 2010/0143695 A1
(43) Pub. Date: Jun. 10, 2010

(54) AUTOMOBILE FLOOR BACK COVERING MATERIAL AND PROCESS FOR PRODUCING THE SAME

(76) Inventors: Masanori Ogawa, Aichi (JP); Makoto Fujii, Aichi (JP)

Correspondence Address: COOPER & DUNHAM, LLP, 30 Rockefeller Plaza, 20th Floor, NEW YORK, NY, 10112, US

(21) Appl. No.: 12/666,524

(22) PCT Filed: Oct. 4, 2007
(86) PCT No.: PCT/JP2007/069449

§ 371 Date: Dec. 23, 2009

(30) Foreign Application Priority Data
Jun. 27, 2007 (JP) 2007-069429

(51) Int. Cl. B32B 3/26; B32B 37/24

(52) U.S. Cl. 428/306.6; 156/242

(57) ABSTRACT

The present invention provides a cover for the backside of a car floor and a method for manufacturing the cover, wherein the cover is manufactured by molding a single thermoplastic sheet 12, or a laminated sheet of the thermoplastic sheet 12 and a synthetic resin impregnated nonwoven porous material sheet 13, which is attached to the outside surface of the thermoplastic sheet 12 as a protective sheet 11, into a predetermined shape by vacuum forming, pressure forming, vacuum and pressure forming, press molding, or heating then cold press molding.

### FIELD OF THE INVENTION

The present invention relates to a cover for the backside of a car floor which is attached to the underside of the car body, and a method for the manufacturing thereof.

### BACKGROUND OF THE INVENTION

A cover for the backside of a car floor which is attached to the underside of a car body has been proposed in such as Patent Literatures 1 to 4. Said proposed cover for the backside of a car floor provides the functions of controlling the flow of air underside of a car, reducing the wind noise, and controlling air resistance on the underside of a car when the car is running, or the like.

Said cover has been manufactured by injection molding using synthetic resin pellets. The first reason why injection molding is employed is that the injection molding is suitable for mass-production, and the second is that the resulting molded article has a level surface, giving the molded article little air flow resistance.
Patent Literature 1: Tokkai JP2006-143140
Patent Literature 2: Tokkai JP2005-088865
Patent Literature 3: Tokkai JP2000-190873
Patent Literature 4: Tookai H11-91642

### DISCLOSURE OF THE INVENTION

### Problems to be Solved by the Invention

To manufacture said cover by injection molding, an expensive mold is necessary, making the manufacturing cost of said cover expensive, and further, the cover as a resulting molded article is heavy.

Accordingly, the object of the present invention is to provide a cover for the backside of a car floor and a method for the manufacturing thereof which can solve said problems.

### Means to Solve Said Problems

The present invention relates to a method for manufacturing a cover for the backside of a car floor which is attached to the underside of a car body, consisting of molding a thermoplastic sheet by vacuum forming, pressure forming, vacuum and pressure forming, press molding, or heating then cold molding, into a predetermined shape.

By using said thermoplastic sheet as a base material for said cover for the backside of a car floor, the weight of said cover can be reduced. Herein, vacuum and pressure forming indicates a forming method, wherein vacuum forming and pressure forming are performed at the same time.

To manufacture said cover, first said thermoplastic sheet may be molded, after which a porous material sheet may be attached to the outside surface of said molded thermoplastic sheet as a protective layer. Said cover is molded into a predetermined shape so that when said cover is attached to the underside of a car body, said protective layer faces the outside (the road). Said protective layer makes up the underside of the car body and protects the outside surface of said cover, and in a case where earth and sand, small stones, water or the like which are splashed by the wheels of the car during driving collide against said cover, the impact energy will be absorbed by said protective layer, resulting in reduced noise, the resistance to chipping of said cover being improved by said protective layer. Further, since said protective layer is made of a porous material, said protective layer further provides sound absorbing properties.

Still further, the present invention relates to a method for preparing a cover for the backside of a car floor which is attached to the underside of a car body, consisting of molding a laminated sheet, wherein a porous material sheet as a protective layer is laminated onto the outside surface of a thermoplastic sheet, into a predetermined shape by vacuum forming, pressure forming, vacuum and pressure forming, press-molding, or heating then cold molding. Using said method, the cover for the backside of a car with a protective layer also can be manufactured. Incidentally, vacuum and pressure forming is a forming method wherein vacuum forming and pressure forming are performed at the same time.

A synthetic resin may be impregnated or coated in/on to said porous material sheet, and by impregnating or coating said synthetic resin in/on to said porous material sheet, various aspects of the performance of said porous material sheet can be improved.

Said porous material sheet may be such as a nonwoven fabric, and said porous material sheet into which said synthetic resin is impregnated may be such as a synthetic resin impregnated nonwoven fabric.

Further, the present invention relates to a cover for the backside of a car floor which is attached to the underside of a car body consisting of a thermoplastic sheet, and a porous material sheet which is attached to the outside surface of said thermoplastic sheet as a protective layer, wherein said cover is molded into a predetermined shape.

Herein, a synthetic resin may be impregnated or coated in/on to said porous material sheet, and a preferable synthetic resin may be a phenol group resin. Further, a resorcine group resin may be preferable as a phenol group resin. In a case where said phenol group resin is impregnated or coated in/on to said porous material sheet, its fire resistant properties may be improved.

Further, a water and oil repellant agent may be mixed into said synthetic resin to improve its water repellency, and oil repellency.

Still further, a colloidal silica may be contained in said porous material sheet to improve its abrasion resistance.

Still further, the surface of said porous material may be leveled by rolling it with a hot press roll. In particular, in a case where said porous material sheet is a nonwoven fabric manufactured by needle punching, leveling with a hot press roll is effective. By said leveling, the air resistance of the resulting cover attached to the underside of the car body may be reduced during driving, giving said cover a high flow conditioning effect.

Still further, said porous material sheet may be such as a nonwoven fabric, and said porous material sheet into which a synthetic resin is impregnated may be such as a synthetic resin impregnated nonwoven fabric.

### EFFECT OF THE INVENTION

Since the method for manufacturing said cover of the present invention uses a thermoplastic sheet as a base material, a light weight cover for the backside of a car floor can be manufactured. Further, in the method, since said cover is molded by vacuum forming, pressure forming, vacuum and pressure forming, press molding, or heating then cold molding, no expensive mold is necessary, so that an inexpensive cover can be manufactured in the present invention.

Still further, since said cover for the backside of a car floor of the present invention has a protective layer, it has excellent sound absorbing, fire resistant, water and oil repellent properties, and resistance to chipping.

### BRIEF DESCRIPTION OF THE DRAWINGS

FIG. 1 is a perspective view of a cover for the backside of a car floor.

FIG. 2 is a perspective view of the front side of the cover.

FIG. 3 is a perspective view of the rear side of the cover.

FIG. 4 is a partially vertical sectional view of the cover for the backside of the car floor 1 (1A, 1B).

### EXPLANATION OF NUMBERS

1. (1A, 1B) Cover of the backside of the car floor
6. Underside of the car body.
11. Protective layer
12. Thermoplastic sheet
13. Synthetic resin impregnated nonwoven fabric (porous material sheet).
15. Laminated sheet

### BEST MODE FOR CARRYING OUT THE INVENTION

The present invention is illustrated below.

### [Thermoplastic Sheet]

The base material of said cover for the backside of a car floor 1 of the present invention is such as a thermoplastic sheet, thermoplastic resin sheet, glass sheet, or paper, or the like. Further, thermoplastic laminated sheet, wherein said thermoplastic fiber sheet and said thermoplastic resin sheet are laminated, may be used.

Said thermoplastic fiber sheet may be such as a fiber sheet into which a thermoplastic resin is impregnated, or a fiber sheet containing a thermoplastic fiber having a low melting point.

The fibers used for the fiber sheet of the present invention include a synthetic fiber such as polyester fiber, polyamide fiber, acrylic fiber, urethane fiber, polyvinylchloraide fiber, polyvinylidenechloraide fiber, acetate fiber, or the like, a vegetable fiber such as kenaf fiber, hemp fiber, palm fiber, bamboo fiber acaba fiber, or the like, an animal fiber such as wool, mohair, cashmere, camel hair, alpaca, vicuna, angora, silk, or the like, a biodegradable fiber made of lactic acid produced from corn starch etc., a cellulose group artificial fiber such as rayon fiber (artificial silk, viscose staple fiber), polynosic fiber, cuprammonium rayon fiber, acetate fiber, triacetate fiber, or the like, an inorganic fiber such as glass fiber, carbon fiber, ceramic fiber, asbestos fiber, or the like, and a reclaimed fiber obtained by the opening of a scrap fiber product made of said fiber(s). Said fiber can be used singly, or two or more kinds of said fiber can be used together in the present invention. The fineness of said synthetic fiber or inorganic fiber may commonly be in the range of between 0.1 and 60 dtex.

In the present invention, a thermoplastic fiber having a melting point below 180° C. may be partially or wholly used as said fiber. Said thermoplastic fiber having a low melting point may be such as a thermoplastic fiber having a melting point below 180° C. such as a polyolefin group fiber such as polyethylene, polypropylene, ethylene-vinyl acetate copolymer, ethylene-ethyl acrylate copolymer, or the like, polyvinyl chloride fiber, polyurethane fiber, polyester fiber, copolymerized polyester fiber, polyamide fiber, copolymerized polyamide fiber, or the like. Said thermoplastic fiber having a low melting point may be used singly, or two or more kinds of said thermoplastic fiber having a low melting point may be used together. The fineness of said thermoplastic fiber having a low melting point is preferably in the range of between 0.1 and 60 dtex. In the present invention, a core-sheath type composite fiber is preferably used, wherein an ordinary fiber is the core component, and a thermoplastic resin having a low melting point in the range of between 100° C. and 180° C. is the sheath component. In a case where said core-sheath type composite fiber is used as the fiber for said fiber sheet, the rigidity and heat resistance of said fiber sheet do not degrade.

Said fiber sheet is manufactured by various methods such as the method wherein a sheet or mat of said fiber web is needle-punched to entangle the fibers in said sheet or mat together, the spun bond method, or the method wherein in a case where said sheet or mat of said fiber web consists of said thermoplastic fiber having a low melting point, or said thermoplastic fiber is mixed into said web, said sheet or mat is heated to soften said thermoplastic fiber having a low melting point and bind said fibers together by melting said thermoplastic fiber having a low melting point, or the method wherein a synthetic resin binder is impregnated into said fiber web to bind said fibers together by said synthetic resin binder, or the method wherein said sheet or mat of said fiber web is needle punched to entangle said fibers in said sheet or mat together, following which said thermoplastic fiber having low melting point is heated and softened to bind said fibers together, or the method wherein said synthetic resin binder is impregnated into the resulting needle punched sheet or mat, to bind said fibers, or the method wherein said fiber is knitted or woven, or the like.

The thermoplastic resin being impregnated into said fiber sheet is such as polyethylene, polypropylene, ethylene-propylene terpolymer, ethylene-vinyl acetate copolymer, polyvinyl chloride, polyvinylidene chloride, polystyrene, polyvinyl acetate, fluorocarbon polymer, thermoplastic acrylic resin, thermoplastic methacrylic resin, thermoplastic polyester, thermoplastic polyamide, thermoplastic polyurethane, acrylonitrile-butadiene-styrene copolymer, or the like. Said thermoplastic resin is preferably provided as an aqueous emulsion or aqueous dispersion for handling, or work such as impregnating, coating or the like.

Said thermoplastic resin preferably has a minimum film forming temperature higher than 20° C., and a glass transition temperature (Tg) higher than 15° C. Said thermoplastic resin provides a thermoplastic sheet having an excellent retention of the molded shape, and good rigidity when said thermoplastic resin is impregnated or coated in/or to said fiber sheet.

Two or more kinds of said thermoplastic resin may be mixed and used together, and one or more kinds of thermosetting resin may be used together with said thermoplastic resin in a small amount so as not to hinder the thermoplasticity of said thermoplastic resin.

Said thermosetting resin may be such as a urethane resin, melamine resin, thermosetting acrylic resin, urea resin, phenol resin, epoxy resin, thermosetting polyester, or the like, and further a synthetic resin precursor to produce said synthetic resin may be used. Said synthetic resin precursor may include such as a prepolymer, oligomer, and monomer such as urethane resin prepolymer, urea resin prepolymer (precondensation polymer), phenol group resin prepolymer (precondensation polymer), diallyl phthalate prepolymer, acrylic oligomer, polyatomic isocyanate, methacrylic ester monomer, diallyl phthalate monomer, or the like. For easy handling, said thermosetting resin is preferably provided as an aqueous solution, aqueous emulsion, or aqueous dispersion.

The addition of said thermosetting resin to said thermoplastic resin improves the retention of the molded shape, and rigidity of said thermoplastic sheet.

Further, an inorganic filler such as calcium carbonate, magnesium carbonate, barium sulfate, calcium sulfate, calcium sulfite, calcium phosphate, calcium hydroxide, magnesium hydroxide, aluminium hydroxide, magnesium oxide, titanium oxide, iron oxide, zinc oxide, alumina, silica, diatomaceous earth, dolomite, gypsum, talc, clay, asbestos, mica, calcium silicate, bentonite, white carbon, carbon black, iron powder, aluminum powder, glass powder, stone powder, blast furnace slag, fly ash, cement, zirconia powder, or the like; a natural rubber or its derivative; a synthetic rubber such as styrene-butadiene rubber, acrylonitrile-butadiene rubber, chloroprene rubber, ethylene-propylene rubber, isoprene rubber, isoprene-isobutylene rubber, or the like; a water soluble polymer or natural gum such as polyvinyl alcohol, sodium alginate, starch, starch derivative, glue, gelatin, powdered blood, methyl cellulose, carboxy methyl cellulose, hydroxy ethyl cellulose, polyacrylate, polyacrylamide, or the like; an organic filler such as wood flour, walnut powder, coconut shell flour, wheat flour, rice flour, or the like, a higher fatty acid such as stearic acid, palmitic acid, or the like; a higher alcohol such as palmityl alcohol, stearyl alcohol, or the like; a fatty acid ester such as butyryl stearate, glycerin mono stearate, or the like; a fatty acid amide; a natural wax or composition wax such as carnauba wax, or the like; a mold release agent such as paraffin, paraffin oil, silicone oil, silicone resin, fluorocarbon polymers, polyvinyl alcohol, grease, or the like; an organic blowing agent such as azodicarbonamide, N,N′-dinitrosopentamethylenetetramine, p,p′-oxybis(benzenesulfonylhydrazide), azobis-2,2′-(2-methylpropionitrile), or the like; an inorganic blowing agent such as sodium bicarbonate, potassium bicarbonate, ammonium bicarbonate or the like; hollow particles such as shirasu balloon, perlite, glass balloon, plastic foaming glass, hollow ceramics, or the like; foaming bodies or particles such as foaming polyethylene, foaming polystyrene, foaming polypropylene, or the like; a pigment; dye; antioxidant; antistatic agent; crystallizer; a flame retarder such as phosphorus compound, nitrogen compound, sulfur compound, boron compound, bromine compound, guanidine compound, phosphate compound, organophosphate compound, amino group resin, or the like; a fireproofing material; flameproof agent; water-repellent agent; oil-repellent agent; insecticide agent; preservative; wax; surfactant; lubricant; antioxidant; ultraviolet absorber; a plasticizer such as phthalic ester (ex. dibutyl phthalate (DBP), dioctyl phthalate (DOP), dicyclohexyl phthalate) and others (ex. tricresyl phosphate), or the like may be mixed into said thermoplastic resin binder.

To impregnate said thermoplastic resin compound into said fiber sheet, said fiber sheet is generally impregnated with a water emulsion or water dispersion of said resin compound, or said water emulsion or water dispersion is coated onto said fiber sheet using a knife coater, roll coater, flow coater, or the like. To adjust the amount of said resin compound in said fiber sheet into which said resin compound is impregnated or mixed, after said resin compound is impregnated or coated in/on to said porous material, said porous material is squeezed using a squeezing roll, press machine, or the like.

In this case the thickness of said fiber sheet is reduced, and in a case where said fiber sheet consists of, or contains a low melting point fiber, it is desirable to heat said fiber sheet and melt said low melting point fiber, so as to bind the fibers with said melted fiber, before said thermoplastic resin is impregnated into said fiber sheet. By doing so, the rigidity and strength of said fiber sheet is further improved, so that the workability of said fiber sheet during the process of impregnating it with said synthetic resin may be improved, resulting in a remarkable restoration of the thickness of said fiber sheet after squeezing.

After said thermoplastic resin is impregnated or coated in/on to said fiber sheet, said fiber sheet is then dried at room temperature or by heating to produce a thermoplastic sheet. The thickness of said fiber sheet is set to be more than 0.2 mm.

As mentioned before, a thermoplastic fiber having a low melting point may be used in said fiber sheet, in this case, since said fiber sheet itself has thermoplasticity, it is not necessary to impregnate or coat said thermoplastic resin in/on to said fiber sheet.

The thermoplastic resin used as the material of said thermoplastic resin sheet is such as an ionomer resin, ethylene-ethyl acrylate (EEA) resin, acrylonitrile-styrene-acrylate copolymer (ASA) resin, acrylonitrile-styrene copolymer (AS) resin, acrylonitrile-chlorinated polyethylene-styrene copolymer (ACS) resin, ethylene-vinyl acetate copolymer (EVA) resin, ethylene-vinyl alcohol copolymer (EVOH) resin, polymethacryl (PMMA) resin, polybutadiene (BDR), polystyrene (PS), polyethylene (PE), acrylonitrile-butadiene-styrene copolymer (ABS) resin, chlorinated polyethylene (CPE), polyvinyl chloride (PVC), polyvinylidene chloride (PVDC), polypropylene (PP), cellulose acetate (CA) resin, syndiotactic polystyrene (SPS), polyoxymethylene (polyacetal, POM), polyamide (PA), polyimide (PI), polyamideimide (PAI), polyetherimide (PEI), polyacrylate (PAR), thermoplastic polyurethane (TPU) elastomer, thermoplastic elastomer (TPE), liquid crystal polymer (LCP), polyetheretherketone (PEEK), polysulfone (PSF), polyethersulfone (PES), fluorocarbon polymer, polytetrafluoroethylene (PTFE), polyethylene terephthalate (PET), polycarbonate (PC), polyphenyleneether (PPE), modified-polyphenyleneether, polyphenylenesuflide (PPS), polybutylene terephthalate (PBT), polybenzimidazole (PBI), wholly aromatic polyester (POB), or the like, and the glass transition point (Tg) of said thermoplastic resin is preferably higher than 15° C., and the hardness determined by the spring type hardness test A type (JIS K 6301) is preferably higher than 30 Hs, more preferably in the range of between 50 and 90 Hs.

Further, a cushion layer may be attached to the backside of said thermoplastic sheet so as to be a laminated sheet, and a protective work cover may be made by molding said laminated sheet. In particular, in a case where said thermoplastic sheet has a high rigidity to improve its shape retaining properties, the scratching of the surface of said thermoplastic sheet is prevented by said cushion layer.

The material of said cushion layer is such as a fiber sheet, foamed plastic sheet, or the like. Said fiber sheet may be the same material as used in said thermoplastic sheet, and said foamed plastic is such as a foamed polyethylene, foamed polypropylene, foamed polyurethane, foamed polystyrene or the like. The thickness of said cushion layer may be set to be more than 1 mm, and preferably less than 10 mm, to ensure its shock absorbing properties.

To attach said cushion layer to said thermoplastic sheet for backing, melting said thermoplastic sheet by heating, or using an adhesive, self (pressure-sensitive) adhesive, two-sided self (pressure-sensitive) adhesive tape, hot melt sheet, hot melt adhesive powder or the like are applied, and further the thermoplastic resin which is impregnated or coated in/on to said thermoplastic sheet may be used to attach said thermoplastic sheet to said cushion layer, or said thermoplastic sheet and said cushion sheet may be bound together by needle punching. In a case where said adhesive or said self (pressure sensitive) adhesive is used, an ordinary organic type solution or aqueous type solution adhesive or a self (pressure sensitive) adhesive may be coated onto said thermoplastic sheet or said cushion layer, or both said thermoplastic sheet and said cushion layer, to attach said thermoplastic sheet and said cushion layer together by spray coating, brush coating, roll coating or the like, and in a case where the two sided self (pressure sensitive) adhesive tape is used, said adhesive tape may intermediate between said thermoplastic sheet and said cushion layer to attach said thermoplastic sheet and said cushion layer together.

Said hot melt sheet or hot melt adhesive powder is made of a synthetic resin having a low melting point such as a polyolefine group resin or polyolefine group resin derivative such as polyethylene, polypropylene, ethylene-vinyl acetate copolymer, ethylene-ethyl acrylate copolymer, or the like, polyurethane, polyester, polyester copolymer, polyamide, polyamide copolymer, or a mixture of two or more kinds of said synthetic resin having a low melting point.

In a case where said hot melt sheet is used to attach said thermoplastic sheet and said cushion sheet, for instance, said hot melt sheet produced by extrusion from a T-die is put onto said thermoplastic sheet, following which said cushion layer is then laminated onto said thermoplastic sheet, followed by hot-pressing.

Further, in the present invention, a thermoplastic resin may be coated or impregnated on/in to a fiber sheet having a predetermined thickness, to form a thermoplastic resin layer having a predetermined thickness less than the thickness of said fiber sheet, so that said thermoplastic resin layer is to be a thermoplastic sheet within said fiber sheet, and the underside of said thermoplastic sheet within said fiber sheet is to be a cushion sheet.

Said thermoplastic sheet preferably has a thickness of between 3 mm and 20 mm.

### [Porous Material Sheet]

Said protective layer of said cover for the backside of a car floor is a sheet of porous material such as non woven fabric. Said porous material may include, for example, a vegetable fiber such as kenaf fiber, hemp fiber, palm fiber, bamboo fiber, abaca fiber, or the like, a synthetic resin fiber such as polyester fiber, polyamide fiber, acrylic fiber, urethane fiber, polyvinyl chloride fiber, polyvinylidene chloride fiber, acetate fiber, or the like, a natural fiber such as wool, mohair, cashmere, camel hair, alpaca, vicuna, angora, silk, or the like, a biodegradable fiber made of lactic acid produced from corn starch etc, a cellulose group artificial fiber such as rayon (artificial silk, viscose staple fiber), polynosic fiber, cuprammonium rayon fiber, acetate fiber, triacetate fiber, or the like, an inorganic fiber such as glass fiber, carbon fiber, ceramic fiber, asbestos fiber, or the like, a reclaimed fiber obtained by the opening of a scrap fiber product made of said fiber(s). Said fiber can be used singly or two or more kinds of said fiber can be used together for said fiber sheet. Or (a) thermoplastic fiber(s) having a low melting point of below 180° C. can be partially or wholly used for said fiber sheet. Said fiber having a low melting point of below 180° C. may include, for example, polyolefin group fiber such as polyethylene, polypropylene, ethylene-vinyl acetate copolymer, ethylene-ethyl acrylate copolymer, or the like, polyvinyl chloride fiber, polyurethane fiber, polyester fiber, copolymerized polyester fiber, polyamide fiber, copolymerized polyamide fiber, or the like, and said porous material for the sheet in the present invention includes foamed plastic such as polystyrene foam, polyethylene foam, polypropylene foam, polyurethane foam or the like. Said fiber sheet is prepared by a process wherein the web sheet or mat of said fiber mixture is intertwined by needle-punching, or a process wherein in a case where said web sheet or mat consists of, or contains a fiber having a low melting point, said sheet or mat is heated to soften said low melting point fiber so as to be a binder, or a process wherein synthetic resin is impregnated or mixed into said sheet or mat as a binder, or a process wherein first said sheet or mat is intertwined by needle punching, then heated to soften said low melting point fiber so as to be a binder, or a process wherein said synthetic resin binder is impregnated into said sheet or mat to bind the fibers in said sheet or mat, or a process wherein said fiber mixture is knitted or woven.

Further said porous material sheet consists of a thin film made of said porous material, preferably having a thickness in the range of between 0.1 mm and 5 mm.

### [Synthetic Resin]

Said synthetic resin which is impregnated or coated in/on to said porous material sheet may include a thermoplastic synthetic resin such as polyethylene, polypropylene, ethylene-propylene copolymer, ethylene-propylene terpolymer, ethylene-vinyl acetate copolymer, polyvinyl chloride, polyvinylidene chloride, polystyrene, polyvinyl acetate, fluorocarbon polymer, thermoplastic acrylic resin, thermoplastic polyester, thermoplastic polyamide, thermoplastic polyurethane, acrylonitrile-butadiene copolymer, butadiene-styrene copolymer, acrylonitrile-butadiene-styrene copolymer, or the like, a thermosetting synthetic resin such as urethane resin, melamine resin, thermosetting acrylic resin, urea resin, phenol resin, epoxy resin, thermosetting polyester, or the like, and further a synthetic resin precursor used to produce said synthetic resin, for example, prepolymer, oligomer, monomer or the like, such as urethane resin prepolymer, epoxy resin prepolymer, melamine resin prepolymer, urea resin prepolymer (precondensation polymer), phenol group resin prepolymer (precondensation polymer), diallyl phthalate prepolymer, acrylic oligomer, polyatomic isocyanate, methacrylic ester monomer, diallyl phthalate monomer, or the like, may be used.

Two or more kinds of said synthetic resin may be used together, and said synthetic resin is generally provided as powder, emulsion, latex, aqueous solution, organic solvent solution, or the like.

A phenol group resin is an especially preferable synthetic resin in the present invention.

Said phenol group resin used in the present invention is described below.

Said phenol group resin is produced by the condensation of a phenol group compound, and formaldehyde or a formaldehyde donor.

### (Phenol Group Compound)

The phenolic compound used to produce said phenolic resin may be a monohydric phenol, or polyhydric phenol, or a mixture of monohydric phenol and polyhydric phenol, but in a case where only a monohydric phenol is used, formaldehyde is apt to be emitted when or after said resin composition is cured, making polyphenol or a mixture of monophenol and polyphenol most desirable.

### (Monohydric Phenol)

The monohydric phenols include an alkyl phenol such as o-cresol, m-cresol, p-cresol, ethylphenol, isopropylphenol, xylenol, 3,5-xylenol, butylphenol, t-butylphenol, nonylphenol or the like; a monohydric derivative such as o-fluorophenol, m-fluorophenol, p-fluorophenol, o-chlorophenol, m-chlorophenol, p-chlorophenol, o-bromophenol, m-bromophenol, p-bromophenol, o-iodophenol, m-iodophenol, p-iodophenol, o-aminophenol, m-aminophenol, p-aminophenol, o-nitrophenol, m-nitrophenol, p-nitrophenol, 2,4-dinitrophenol, 2,4,6-trinitrophenol or the like; a monohydric phenol of a polycyclic aromatic compound such as naphthol or the like. Each monohydric phenol can be used singly, or as a mixture thereof.

### (Polyhydric Phenol)

The polyhydric phenols mentioned above, include resorcin, alkylresorcin, pyrogallol, catechol, alkyl catechol, hydroquinone, alkyl hydroquinone, phloroglucinol, bisphenol, dihydroxynaphthalene or the like. Each polyhydric phenol can be used singly, or as a mixture thereof. Resorcin and alkylresorcin are more suitable than other polyhydric phenols. Alkylresorcin, in particular, is the most suitable of polyhydric phenols because alkylresorcin can react with aldehydes more rapidly than resorcin.

The alkylresorcins include 5-methyl resorcin, 5-ethyl resorcin, 5-propyl resorcin, 5-n-butyl resorcin, 4,5-dimethyl resorcin, 2,5-dimethyl resorcin, 4,5-diethyl resorcin, 2,5-diethyl resorcin, 4,5-dipropyl resorcin, 2,5-dipropyl resorcin, 4-methyl-5-ethyl resorcin, 2-methyl-5-ethyl resorcin, 2-methyl-5-propyl resorcin, 2,4,5-trimethyl resorcin, 2,4,5-triethyl resorcin, or the like.

A polyhydric phenol mixture produced by the dry distillation of oil shale, which is produced in Estonia is inexpensive, includes 5-methyl resorcin, along with many other kinds of alkylresorcin which is highly reactive, so that said polyhydric phenol mixture is an especially desirable raw polyphenol material in the present invention.

Further, among said polyhydric phenols, one or a mixture of two or more kinds of resorcin group compound such as resorcin, alkylresorcin or the like (including a polyhydric phenol mixture produced by the dry distillation of oil shale which is produced in Estonia), and a resorcin group resin consisting of aldehyde and/or an aldehyde donor, are desirably used as a phenol group resin in the present invention.

### [Formaldehyde Donor]

In the present invention, said phenolic compound and aldehyde and/or aldehyde donor (aldehydes) are condensed together. Said aldehyde donor refers to a compound or a mixture thereof which emits aldehyde when said compound or said mixture decomposes. Said aldehyde donor is such as paraformaldehyde, trioxane, hexamethylenetetramine, tetraoxymethylene, or the like. In the present invention, a formaldehyde and formaldehyde donor are denominated together as a formaldehyde group compound.

### [Production of Phenol Group Resin]

Said phenol group resin has two types, one is a resol type, which is produced by the reaction between said phenol group compound and an excess amount of said formaldehyde group compound using an alkali as a catalyst, and the other novolak type is produced by the reaction between an excess amount of said phenol group compound and said formaldehyde group compound using an acid as a catalyst. Said resol type phenol group resin consists of various phenol alcohols produced by the addition of formaldehyde to phenol, and is commonly provided as a water solution, while said novolak phenol group resin consists of various dihydroxydiphenylmethane group derivatives, wherein the phenol group compounds are further condensed with phenol alcohols, said novolak type phenol group resin being commonly provided as a powder.

In the use of said phenol group resin in the present invention, said phenol group compound is first condensed with a formaldehyde group compound to produce a precondensate, after which the resulting precondensate is applied to said fiber sheet, which is followed by resinification with a curing agent, and/or heating.

To produce said condensate, monohydric phenol may be condensed with a formaldehyde group compound to produce a homoprecondensate, or a mixture of monohydric phenol and polyhydric phenol may be condensed with a formaldehyde group compound to produce a coprecondensate of monohydric phenol and polyhydric phenol. To produce said coprecondensate, either of said monohydric phenol or polyhydric phenol may be previously condensed with said formaldehyde group compound to produce a precondensate, or both monohydric phenol and polyhydric phenol may be condensed together.

In the present invention, the desirable phenolic resin is phenol-alkylresorcin cocondensation polymer. Said phenol-alkylresorcin cocondensation polymer provides a water solution of said cocondensation polymer (pre-cocondensation polymer) having good stability, and being advantageous in that it can be stored for a longer time at room temperature, compared with a condensate consisting of only a phenol (precondensation polymer). Further, in a case where said sheet material is impregnated or coated with said water solution, and then precured, said material has good stability and does not lose its moldability after longtime storage. Further, since alkylresorcin is highly reactive to a formaldehyde group compound, and catches free aldehyde to react with it, the content of free aldehyde in the resin can be reduced.

The desirable method for producing said phenol-alkylresorcin cocondensation polymer is first to create a reaction between phenol and a formaldehyde group compound to produce a phenolic precondensation polymer, and then to add alkylresorcin, and if desired, a formaldehyde group compound, to said phenolic precondensation polymer to create a reaction.

In the case of method (a), for the condensation of monohydric phenol and/or polyhydric phenol and a formaldehyde group compound, said formaldehyde group compound (0.2 to 3 moles) is added to said monohydric phenol (1 mole), after which said formaldehyde group compound (0.1 to 0.8 mole) is added to the polyhydric phenol (1 mole) as usual. If necessary, additives may be added to the phenol resins (the precondensation polymers). In said method(s), there is a condensation reaction caused by applying heat at 55° C. to 100° C. for 8 to 20 hours. The addition of said formaldehyde group compound may be made at once at the beginning of the reaction, or several separate times throughout the reaction, or said formaldehyde group compound may be dropped in continuously throughout said reaction.

Further, if desired, the phenol resins and/or precondensation polymers thereof may be copolycondensed with amino resin monomers such as urea, thiourea, melamine, thiomelamine, dicyandiamine, guanidine, guanamine, acetoguanamine, benzoguanamine, 2,6-diamino-1,3-diamine, and/or with the precondensation polymers of said amino resin monomers.

To produce said phenolic resin, a catalyst or a pH control agent may be mixed in, if needed, before, during or after reaction. Said catalyst or pH control agent is, for example, an organic or inorganic acid such as hydrochloric acid, sulfuric acid, orthophosphoric acid, boric acid, oxalic acid, formic acid, acetic acid, butyric acid, benzenesulfonic acid, phenolsulfonic acid, p-toluenesulfonic acid, naphthalene-α-sulfonic acid, naphthalene-3-sulfonic acid, or the like; an organic acid ester such as oxalic dimethyl ester, or the like; an acid anhydride such as maleic anhydride, phthalic anhydride, or the like; an ammonium salt such as ammonium chloride, ammonium sulfate, ammonium nitrate, ammonium oxalate, ammonium acetate, ammonium phosphate, ammonium thiocyanate, ammonium imide sulfonate, or the like; an organic halide such as monochloroacetic acid or its sodium salt, α,α′-dichlorohydrin, or the like; a hydrochloride of amines such as triethanolamine hydrochloride, aniline hydrochloride, or the like; a urea adduct such as salicylic acid urea adduct, stearic acid urea adduct, heptanoic acid urea adduct, or the like; an acid substance such as N-trimethyl taurine, zinc chloride, ferric chloride, or the like; ammonia, amines, an hydroxide of an alkaline metal or alkaline earth metal such as sodium hydroxide, potassium hydroxide, barium hydroxide, calcium hydroxide, or the like; an oxide of an alkalineearth metal such as lime, or the like; an alkaline substance such as an alkalinemetal salt of weak acid such as sodium carbonate, sodium sulfite, sodium acetate, sodium phosphate or the like.

Further, curing agents such as a formaldehyde group compound or an alkylol triazone derivative, or the like, may be added to said phenolic precondensation polymer (including precocondensation polymer).

Said alkylol triazone derivative is produced by the reaction between the urea group compound, amine group compound, and formaldehyde group compound. Said urea group compound used in the production of said alkylol triazone derivative may be such as urea, thiourea, an alkylurea such as methylurea or the like; an alkylthiourea such as methylthiourea or the like; phenylurea, naphthylurea, halogenated phenylurea, nitrated alkylurea, or the like, or a mixture of two or more kinds of said urea group compound. A particularly desirable urea group compound may be urea or thiourea. As amine group compounds, an aliphatic amine such as methyl amine, ethylamine, propylamine, isopropylamine, butylamine, amylamine or the like, benzylamine, furfuryl amine, ethanol amine, ethylmediamine, hexamethylene diamine hexamethylene tetramine, or the like, as well as ammonia are illustrated, and said amine group compound is used singly or two or more amine group compounds may be used together. The formaldehyde group compound(s) used for the production of said alkylol triazone derivative is (are) the same as the formaldehyde group compound(s) used for the production of said phenolic resin precondensation polymer.

To synthesize said alkylol triazone derivatives, commonly 0.1 to 1.2 moles of said amine group compound(s) and/or ammonia, and 1.5 to 4.0 moles of said formaldehyde group compound are reacted with 1 mole of said urea group compound. In said reaction, the order in which said compounds are added is arbitrary, but preferably, the required amount of formaldehyde group compound is first put in a reactor, after which the required amount of amine group compound(s) and/or ammonia is (are) gradually added to said formaldehyde group compound, the temperature being kept at below 60° C., after which the required amount of said urea group compound(s) is (are) added to the resulting mixture at 80 to 90° C., for 2 to 3 hours, being agitated so as to react together. Usually, 37% by mass of formalin is used as said formaldehyde group compound, but some of said formalin may be replaced with paraformaldehyde to increase the concentration of the reaction product. Further, in a case where hexamethylene tetramine is used, the solid content of the reaction product obtained is much higher. The reaction between said urea group compound, said amine group compound and/or ammonia, and said formaldehyde group compound is commonly performed in a water solution, but said water may be partially or wholly replaced with one or more kinds of alcohol such as methanol, ethanol, isopropanol, n-butanol, ethylene glycol, diethlene glycol, or the like, and one or more kinds of other water soluble solvent such as ketone group solvent like acetone, methylethyl ketone, or the like can also be used as solvents. The amount of said curing agent to be added is, in the case of a formaldehyde group compound, in the range of between 10 and 100 parts by mass to 100 parts by mass of said phenolic resin precondensation polymer (precocondensation polymer) of the present invention, and in the case of alkylol triazone, 10 to 500 parts by mass to 100 parts by mass of said phenolic resin precondensation polymer (precocondensation polymer).

[Sulfomethylation and/or Sulfimethylation of Phenol Group Resin]

To improve the stability of said water soluble phenol group resin, said phenol group resin is preferably sulfomethylated and/or sulfimethylated.

### [Sulfomethylation Agent]

The sulfomethylation agents used to improve the stability of the aqueous solution of phenol resins, include such as water soluble sulfites prepared by the reaction between sulfurous acid, bisulfurous acid, or metabisulfurous acid, and alkaline metals, trimethyl amine, quaternary amine or quaternary ammonium (e.g. benzyltrimethylammonium); and aldehyde additions prepared by the reaction between said water soluble sulfites and aldehydes.

The aldehyde additions are prepared by the addition reaction between aldehydes and water soluble sulfites as mentioned above, wherein the aldehydes include formaldehyde, acetoaldehyde, propionaldehyde, chloral, furfural, glyoxal, n-butylaldehyde, caproaldehyde, allylaldehyde, benzaldehyde, crotonaldehyde, acrolein, phenyl acetoaldehyde, o-tolualdehyde, salicylaldehyde, or the like. For example, hydroxymethane sulfonate, which is one of the aldehyde additions, is prepared by the addition reaction between formaldehyde and sulfite.

### [Sulfimethylation Agent]

The sulfimethylation agents used to improve the stability of the aqueous solution of phenol resins, include alkaline metal sulfoxylates of an aliphatic or aromatic aldehyde such as sodium formaldehyde sulfoxylate (a.k.a. Rongalite), sodium benzaldehyde sulfoxylate, or the like; hydrosulfites (a.k.a. dithionites) of alkaline metal or alkaline earth metal such as sodium hydrosulfite, magnesium hydrosulfite or the like; and a hydroxyalkanesulfinate such as hydroxymethanesulfinate or the like.

In a case where said phenol group resin precondensate is sulfomethylated and/or sulfimethylated, said sulfomethylation agent and/or sulfimethylation agent is(are) added to said precondensate at any stage to sulfomethylate and/or sulfimethylate said phenol group compound and/or said precondensate.

The addition of said sulfomethylation agent and/or sulfimethylation agent may be carried out at any stage, before, during or after the condensation reaction.

The total amount of said sulfomethylation agent and/or sulfimethylation agent to be added is in the range of between 0.001 and 1.5 moles per 1 mole of said phenol group compound. In a case where the total amount of said sulfomethylation agent and/or sulfimethylation agent to be added is less than 0.001 mole per 1 mole of said phenol group compound, the resulting phenol group resin has an insufficient hydrophilic property, while in a case where the total amount of said sulfomethylation agent and/or sulfimethylation agent to be added is beyond 1.5 moles per 1 mole of said phenol group compound, the resulting phenol group resin has insufficient water resistance. To maintain good performance, such as the curing capability of said produced precondensate, and the properties of the resin after curing, or the like, the total amount of said sulfomethylation agent and/or sulfimethylation agent is preferably set to be in the range of between about 0.01 and 0.8 mole for said phenol group compound.

Said sulfomethylation agent and/or sulfimethylation agent added to said precondensate, to the sulfomethylation and/or sulfimethylation of said precondensate, react(s) with the methylol group of said precondensate, and/or the aromatic group of said precondensate, introducing a sulfomethyl group and/or sulfimethyl group to said precondensate.

As described above, an aqueous solution of sulfomethylated and/or sulfimethylated phenol group resin precondensate is stable in a wide range, between acidity (pH1.0), and alkalinity, with said precondensate being curable in any range, acidity, neutrality, or alkalinity. In particular, in a case where said precondensate is cured in an acidic range, the remaining amount of said methylol group decreases, solving the problem of formaldehyde being produced by the decomposition of said cured precondensate.

Into said synthetic resin used in the present invention, further, an inorganic filler, such as calcium carbonate, magnesium carbonate, barium sulfate, calcium sulfate, calcium sulfite, calcium phosphate, calcium hydroxide, magnesium hydroxide, aluminium hydroxide, magnesium oxide, titanium oxide, iron oxide, zinc oxide, alumina, silica, diatomaceous earth, dolomite, gypsum, talc, clay, asbestos, mica, calcium silicate, bentonite, white carbon, carbon black, iron powder, aluminum powder, glass powder, stone powder, blast furnace slag, fly ash, cement, zirconia powder, or the like; a natural rubber or its derivative; a synthetic rubber such as styrene-butadiene rubber, acrylonitrile-butadiene rubber, chloroprene rubber, ethylene-propylene rubber, isoprene rubber, isoprene-isobutylene rubber, or the like; a water-soluble macromolecule and natural gum such as polyvinyl alcohol, sodium alginate, starch, starch derivative, glue, gelatin, powdered blood, methyl cellulose, carboxy methyl cellulose, hydroxy ethyl cellulose, polyacrylate, polyacrylamide, or the like; an organic filler such as, wood flour, walnut powder, coconut shell flour, wheat flour, rice flour, or the like; a higher fatty acid such as stearic acid, palmitic acid, or the like; a fatty alcohol such as palmityl alcohol, stearyl alcohol, or the like; a fatty acid ester such as butyryl stearate, glycerin mono stearate, or the like; a fatty acid amide; a natural wax or composition wax such as carnauba wax, or the like; a mold release agent such as paraffin, paraffin oil, silicone oil, silicone resin, fluorocarbon polymers, polyvinyl alcohol, grease, or the like; an organic blowing agent such as azodicarbonamido, dinitroso pentamethylene tetramine, p,p′-oxibis(benzene sulfonylhydrazide), azobis-2,2′-(2-methylpropionitrile), or the like; an inorganic blowing agent such as sodium bicarbonate, potassium bicarbonate, ammonium bicarbonate or the like; hollow particles such as shirasu balloon, perlite, glass balloon, plastic foaming glass, hollow ceramics, or the like; foaming bodies or particles such as foaming polyethylene, foaming polystyrene, foaming polypropylene, or the like; a pigment; dye; antioxidant; antistatic agent; crystallizer; flameproof agent; water-repellent agent; oil-repellent agent; insecticide agent; preservative; wax; surfactant; lubricant; antioxidant; ultraviolet absorber; plasticizer such as phthalic ester (ex. dibutyl phthalate (DBP), dioctyl phthalate (DOP), dicyclohexyl phthalate) and others (ex. tricresyl phosphate) may be added or mixed.

### [Colloidal Silica]

The colloidal silica used in the present invention is minute particle silica or alumina coated minute particle silica, and generally the average particle size of said colloidal silica is in the range of between 1 to 100 μm, preferably 3 to 50 μm. Said colloidal silica is generally provided as a dispersion in which said colloidal silica is dispersed in water. In a case where the average particle size of said minute particle silica is beyond 100 μm, it is feared that the resin oozing layer will become whitish, and in a case where the average particle size of said minute particle silica is under 1 μm, the surface area of said minute particle silica will expand excessively and negatively influence the stability of the dispersion.

A water and oil repellant agent of the present invention include such as natural wax, synthetic wax, fluorocarbon resin, silicon group resin or the like.

### [Molding of Thermoplastic Sheet]

Said thermoplastic sheet of the present invention is molded by vacuum forming, pressure forming, vacuum and pressure forming, press molding, or heating then cold molding.

In a case where said cover for the backside of a car floor is manufactured by vacuum forming, said thermoplastic sheet is first heated to soften, after which the resulting softened thermoplastic sheet is put onto the prescribed mold, then the space between said softened thermoplastic sheet and said mold is vacuumed, keeping said thermoplastic sheet soft so that said thermoplastic sheet is pressed into said mold. Following this, said thermoplastic sheet is then cooled to obtain a molded article (a cover for the backside of a car floor) having a predetermined shape.

How to attach the resulting cover for the backside of a car floor is described below.

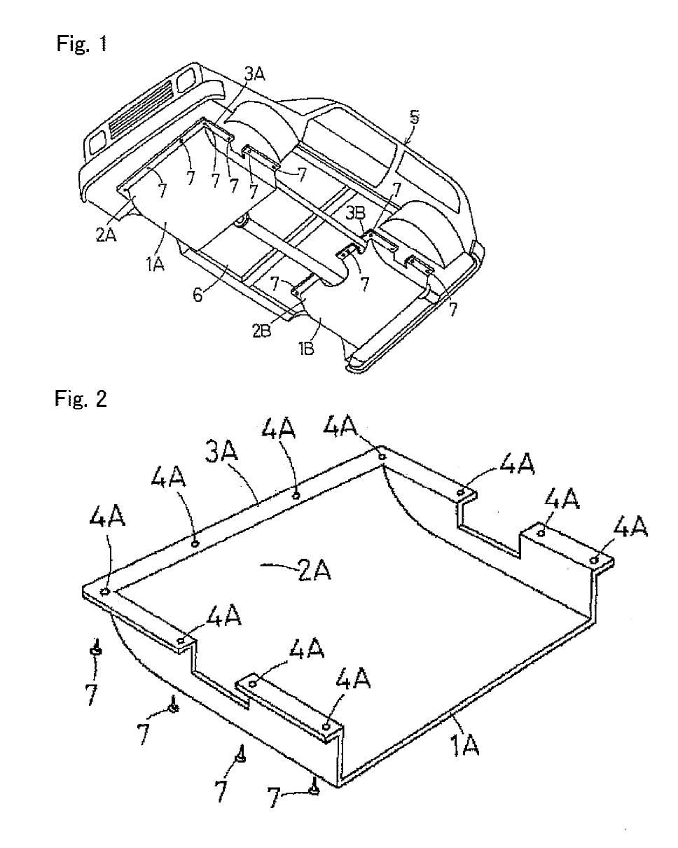

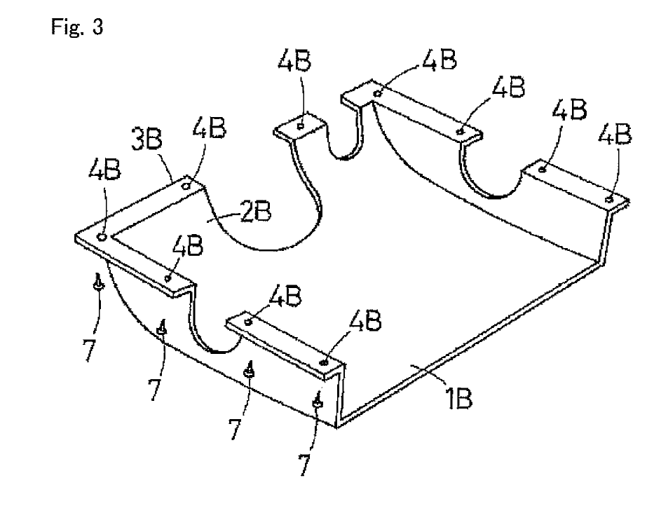

As shown in FIG. 1, said covers for the backside of a car floor 1 (1A, 1B) each have streamlined front parts 2A, 2B, the upper edges of said streamlined front parts 2A, 2B of said cover 1A, 1B having a plural number of clip holes 4A, 4B so that said upper edges are each to be attaching flanges 3A, 3B.

Said covers 1A, 1B are each attached to the underside 6 of the car body 5 being the backside of the car floor with screws 7 to cover the undersides of components such as engine, transmission, fuel tank, muffler, working device, propeller shaft or the like, said components being arranged on the backside of the car body 6.

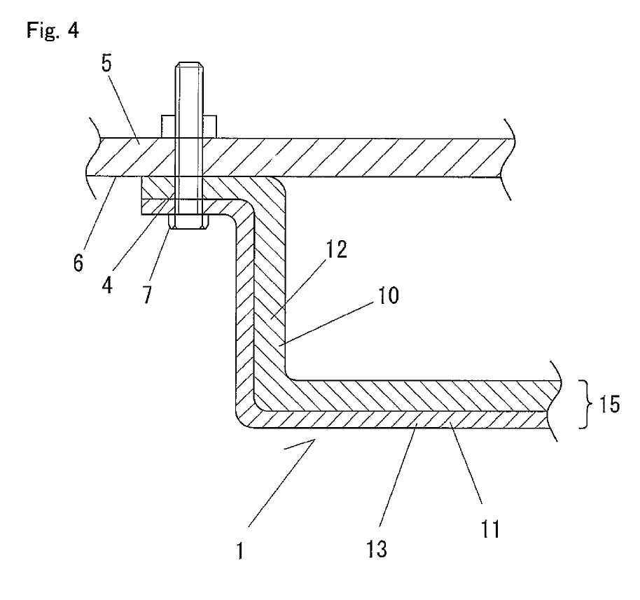

Said covers 1A, 1B are attached to the underside of the car body so as to face said thermoplastic sheet 12 as said base layer 10 toward the inside (car body side), and face nonwoven fabric 13 into which a synthetic resin is impregnated as said protective layer 11 toward the outside (road side), as shown in FIG. 4.

As described above, said cover 1 for the backside of a car floor is manufactured by vacuum forming, pressure forming, vacuum and pressure forming, press molding, or heating then cold molding into a prescribed shape. Further, said nonwoven fabric 13 into which the synthetic resin is impregnated as a protective layer 11 may be attached to the outside surface of said thermoplastic sheet 12 after said thermoplastic sheet 12 is molded. Still further, laminated sheet 15, wherein said nonwoven fabric 13 into which the synthetic resin is impregnated as said protective layer 11 is attached to the outside surface of said thermoplastic sheet 12, may be molded by vacuum forming, pressure forming, vacuum and pressure forming, press molding or heating then cold molding into a prescribed shape.

Further, one or both sides of said nonwoven fabric into which said synthetic resin is impregnated may be leveled by the calendar treatment in which said nonwoven fabric is rolled by a hot press roll.

The places onto which said covers 1A, 1B are attached are not limited to the places shown in FIG. 1, and further, said cover(s) (1A, 1B) may be attached to the underside of the car body 6 by using an adhesive.

### Example 1

A fiber mixture containing 60 parts by mass of a polyester fiber (fineness: 4.0 dtex, length: 60 mm), 5 parts by mass of a polypropylene fiber (fineness: 1.5 dtex, length: 55 mm), 35 parts by mass of a core-sheath type composite polyester fiber as fiber having a low melting point (fineness: 4.4 dtex, melting point of the sheath component: 150° C., length: 55 mm) was opened by an opening machine so as to be a web, following which the resulting fiber mixture web was introduced into the heating oven at 180° C. to melt said fiber having a low melting point, gradually adjusting the thickness of said fiber mixture web to obtain a thermoplastic sheet (A) having an unite weight of 1000 g/m². The resulting thermoplastic sheet (A) was then kept at 200° C. for one minute in a thermostatic circulating hot air chamber, immediately after which the resulting thermoplastic sheet was molded by a cold press molding machine to obtain a cover (1), consisting of a thermoplastic sheet having a thickness of 10 mm, for the backside of the car floor. The resulting cover (1) had a light weight and excellent workability.

### Example 2

A fiber mixture containing 20 parts by mass of a polyester fiber (fineness: 4.0 dtex, length: 60 mm), 50 parts by mass of a kenaf fiber (fineness: 20 to 30 detex, length: 75 mm), and 30 parts by mass of a core-sheath type composite polyester fiber as a fiber having a low melting point (fineness: 4.4 detx, the melting point of the sheath component: 150° C., length: 55 mm) was opened by the opening machine so as to be a web, and after that the resulting fiber mixture web was needle punched, and the resulting needle punched fiber mixture web was then introduced into the heating oven at 180° C. to melt said fiber having a low melting point, gradually adjusting the thickness of said fiber mixture web, followed by heat treating the resulting heated needle punched fiber mixture web at 200° C. for one minute in the thermostatic circulating hot air chamber, and immediately after which the resulting thermoplastic sheet was molded by the cold press molding machine to obtain a molded thermoplastic sheet (B) having a thickness of 10 mm, and unit weight of 120 g/m².

On the other hand, a mixture solution containing 30 parts by mass of a resol type phenol-alkylresorcin-formaldehyde precondensation polymer (aqueous solution having a solid content of 50% by mass), one part by mass of a carbon black (aqueous dispersion having a solid content of 30% by mass), two parts by mass of a fluorine group water and oil repellent agent (aqueous solution having a solid content of 20% by mass), and 67 parts by mass of water was prepared, then the resulting mixture solution was coated and impregnated on/in to a nonwoben fabric consisting of a polyester fiber and manufactured by the spun bond method, having a unit weight of 110 g/m², by the roll in an amount to be 30% for said nonwoven fabric.

A polyamide copolymer (particle size: 200˜250 μm, melting point: 130° C.) was scattered on the surface of said nonwoven fabric into which said mixture solution was impregnated, in an amount of 20 g/m², after which the resulting nonwoven fabric was dried at 180° C. for three minutes, to obtain a porous material sheet (c) having a thickness of 1 mm. The resulting porous material (C) was then put on said thermoplastic sheet (B) manufactured as described above, and having a thickness of 10 mm, so as to attach the surface of said porous material sheet (C) onto which said hot melt adhesive was scattered, to the surface of said thermoplastic sheet (B), the resulting laminated sheet then being lightly pressed on the hot plate at 150° C. from said porous material sheet side for 20 seconds. The resulting laminated sheet was then molded by cold pressing to obtain a cover (II) for backside of a car floor having a thickness of 11 mm. The resulting cover had excellent wear resistance and aerodynamic properties.

### Example 3

A fiber mixture containing 40 parts by mass of a polyester fiber (fineness: 4.5 dtexk length: 70 mm), 30 parts by mass of a carbon fiber (fineness: 1.1 dtx, length: 75 mm), and 30 parts by mass of a core-sheath type composite fiber as a fiber having a low melting point (fineness: 4.4 dtex, melting point of the sheath component: 160° C., length: 55 mm) was opened by the opening machine so as to be a web, after which the resulting fiber mixture web was introduced into the heating oven at 180° C. to melt said fiber having a low melting point, gradually adjusting the thickness of said fiber mixture web to obtain a cushion layer sheet (D) having a thickness of 5 mm, and a unit weight of 200 g/m². The resulting cushion layer sheet (D) was put on one side of said thermoplastic sheet (B) prepared in EXAMPLE 2, a polyester film with a melting point of 120° C. and thickness of 0.1 mm intermediating as a hot melt adhesive, and further said porous material sheet (C) prepared in EXAMPLE 2 was put on the other side of said thermoplastic sheet (B) so as to attach the surface of said porous material sheet (C) onto which said hot melt adhesive was scattered, to the surface of said thermoplastic sheet (B). The resulting laminated sheet was then lightly pressed by the hot press machine at 180° C. for one minute, after which said laminated sheet was then immediately cold pressed by the cold press molding machine to obtain a cover (lll) for the backside of a car floor having a thickness of 10 mm. The resulting cover had an excellent shape retaining property and rigidity since said cushion layer sheet was laminated to the inside of said cover.

### Example 4

A fiber mixture containing 60 parts by mass of a polyester fiber (fineness: 3.3 dtex, length: 70 mm), 10 parts by mass of a hemp fiber (fineness: 5.0 detex, length: 75 mm), and 40 parts by mass of a core-sheath type composite fiber as a fiber having a low melting point (fineness: 4.4 dtex, melting point of the sheath component: 150° C., length: 55 mm) was opened by the opening machine so as to be a web, and after which the resulting fiber mixture web was needle punched, and the resulting needle punched fiber mixture web was then introduced into the heating oven at 180° C. to melt said fiber having a low melting point, gradually adjusting the thickness of said fiber mixture web to be 20 mm, with a unit of 1200 g/m².

A mixture solution containing 30 parts by mass of an acrylic emulsion (the lowest film forming temperature: 35° C. Tg: 20° C., solid content: 45%), 3 parts by weight of a fluorine water and oil repellent agent, and 67 parts by mass of water was prepared, after which the resulting mixture solution was then impregnated into said fiber mixture web manufactured as described above in an amount of 25% by weight for said fiber mixture web by the roll, after which the resulting fiber mixture web was then suction dried at 130° C. for 5 minutes to obtain a thermoplastic sheet (E), having a thickness of 15 mm.

On the other hand, a mixture solution containing 40 parts by mass of a resol type sufomethylated phenol-alkyl resorcin-formaldehyde precondensation polymer (aqueous solution having a solid content of 50% by mass), 20 parts by mass of a colloidal silica (Trade name: Snowtex 20, Nissan Chemical Industries, Ltd.), one part by mass of a carbon black (aqueous solution having a solid content 30% by mass), two parts by mass of a fluorine group water and oil repellent agent (aqueous solution having a solid content 20% by mass) and 37 parts by mass of water was prepared.

The resulting mixture solution was then impregnated into a nonwoven fabric made of a polyester fiber and manufactured by the spunbond method, having a unit weight 110 g/m², by the roll in an amount to be 30% by mass for said nonwoven fabric, and further a polyamide copolymer (particle size: 200 to 250 μm, melting point: 130° C.) was scattered on the surface of the resulting nonwoven fabric into which said mixture solution was impregnated, in an amount of 20 g/m², and then said nonwoven fabric was dried at 140° C. for three minutes, to obtain a porous material sheet (F) having a thickness of 1.5 mm. A pair of the resulting porous material sheets (F) were put on both sides of said thermoplastic sheet (E) prepared as described above so as to attach the surface of each porous material sheet (F) onto which said hot melt adhesive was scattered, to the surface of said thermoplastic sheet (E), after which the resulting laminated sheet was lightly pressed on a hot plate at 200° C. for 20 seconds. After this the resulting pressed laminated sheet was cold-pressed to obtain a cover (IV) for the backside of a car floor, the resulting cover having an excellent wear resistance and resistance to chipping.

### Example 5

A fiber mixture containing 80 parts by mass of a polyester fiber (fineness: 4.0 detex, length: 60 mm) and 20 parts by mass of a core-sheath type composite polyester fiber (fineness: 4.4 detex, melting point of the sheath component: 130° C., length: 75 mm) was opened by the opening machine so as to be a web, after which the resulting fiber mixture web was needle punched to manufacture a nonwoven fabric having a thickness of 5 mm and unit weight of 150 g/m². One side of the resulting nonwoven fabric was treated by calendar rolling at 200° C., to obtain a nonwoven fabric one side of which was level.

A mixture solution containing 40 parts by weight of a resol type sulfimethylated alkylresorcin-formaldehyde precondensation polymer (aqueous solution having a solid content 50% by mass), one part by mass of a carbon black (aqueous dispersion having a solid content of 30% by mass), two parts by mass of a fluorine group water and oil repellent agent (aqueous solution having a solid content of 20% by mass), 10 parts by mass of a flame-retardant containing organic phosphorus compound and nitrogen compound (aqueous solution having a solid content of 40% by mass), and 47 parts by mass of water was prepared, after which said mixture solution was then coated and impregnated on/in to the resulting nonwoven fabric, one side of which was level, in an amount to be 30% by mass for said nonwoven fabric, and a mixture solution containing 30 parts by mass of a polyester powder (melting point: 130° C., particle size: 40 to 50 μm), one part by mass of an aqueous solution containing 0.1% by mass of a polysodium acrylate, and 69 parts by mass of water was sprayed onto the other side of said nonwoven fabric, without having been calendar roll treated, in an amount of 5 g/m² as solid, the resulting nonwoven fabric, the other side of which said mixture solution was coated on, was dried at 140° C. for four minutes to obtain a porous material sheet (G). Following this, a pair of said porous material sheets (G) were put on the either side of said thermoplastic sheet (A) prepared in EXAMPLE 1, and then the resulting laminated sheet was molded by hot pressing at 200° C. for one minute, to obtain a cover (V) for the backside of a car floor having a thickness of 8 mm. Said cover had excellent flame retardancy and a level surface since said porous material sheet was leveled by the calendar treatment, so that said cover had excellent aerodynamics.

### POSSIBILITY OF INDUSTRIAL USE

The present invention provides a cover for the backside of a car floor which is attached to the underside of a car body and the method for the manufacturing thereof, so that the present invention can be used industrially.

1. A cover for the backside of a car floor which is attached to the underside of a car body, comprising a thermoplastic fiber sheet and a porous material sheet, which is attached to the outside surface of said thermoplastic sheet as a protective layer, wherein said cover is molded into a predetermined shape by vacuum forming, pressure forming, vacuum and pressure forming, hot press molding, or heating then cold press molding.

2. A cover for the backside of a car floor in accordance with claim 1, wherein a synthetic resin is impregnated or coated in/on to said porous material sheet.

3. A cover for the backside of a car floor in accordance with claim 2, wherein said synthetic resin is a phenol group resin.

4. A cover for the backside of a car floor in accordance with claim 3, wherein said phenol group resin is a resorcin group resin.

5. A cover for the backside of a car floor in accordance with claim 2, wherein a water and oil repellent agent is mixed into said synthetic resin which is impregnated or coated in/on to said porous material sheet.

6. A cover for the backside of a car floor in accordance with claim 1, wherein a colloidal silica is contained in said porous material sheet.

7. A cover for the backside of a car floor in accordance with claim 1, wherein the surface of said porous material sheet is leveled by calendering with a hot press roll.

8. A cover for the backside of a car floor in accordance with claim 1, wherein said porous material sheet is a nonwoven fabric.

9. A method for manufacturing said cover for the backside of a car floor in accordance with claim 1, consisting of molding said thermoplastic fiber sheet into a predetermined shape by vacuum forming, pressure forming, vacuum and pressure forming, hot-press molding, or heating then cold press molding, then attaching a porous material sheet to the outside surface of said thermoplastic fiber sheet as a protective layer.

10. A method for manufacturing said cover for the backside of a car floor which is attached to the underside of a car body in accordance with claim 1, consisting of molding a laminated sheet, wherein a porous material sheet is attached to the outside surface of said thermoplastic fiber sheet as a protective layer, into a predetermined shape by vacuum forming, pressure forming, vacuum and pressure forming, hot press molding, or heating then cold press molding.

11. A method for manufacturing said cover for the backside of a car floor in accordance with claim 9, wherein a synthetic resin is impregnated or coated in/on said porous material sheet.

12. A method for manufacturing said cover for the backside of a car floor in accordance with claim 9, wherein said porous material sheet is a nonwoven fabric.

13. (canceled)

14. A method for manufacturing said cover for the backside of a car floor in accordance with claim 10, wherein a synthetic resin is impregnated or coated in/on said porous material sheet.

15. A method for manufacturing said cover for the backside of a car floor in accordance with claim 10, wherein said porous material sheet is a nonwoven fabric.

16. A method for manufacturing said cover for the backside of a car floor in accordance with claim 11, wherein said porous material sheet is a nonwoven fabric.

17. A cover for the backside of a car floor in accordance with claim 3, wherein a water and oil repellent agent is mixed into said synthetic resin which is impregnated or coated in/on to said porous material sheet.

18. A cover for the backside of a car floor in accordance with claim 4, wherein a water and oil repellent agent is mixed into said synthetic resin which is impregnated or coated in/on to said porous material sheet.

19. A cover for the backside of a car floor in accordance with claim 2, wherein a colloidal silica is contained in said porous material sheet.

20. A cover for the backside of a car floor in accordance with claim 3, wherein a colloidal silica is contained in said porous material sheet.

21. A cover for the backside of a car floor in accordance with claim 4, wherein a colloidal silica is contained in said porous material sheet.

22. A cover for the backside of a car floor in accordance with claim 5, wherein a colloidal silica is contained in said porous material sheet.

23. A cover for the backside of a car floor in accordance with claim 2, wherein a colloidal silica is contained in said porous material sheet.

24. A cover for the backside of a car floor in accordance with claim 1, wherein the cover consists of said thermoplastic fiber sheet and said porous material sheet.
